(19) United States
(12) Patent Application Publication
(10) Pub. No.: US 2021/0062983 A1
(43) Pub. Date: Mar. 4, 2021

(54) LIGHT DEVICE

(71) Applicant: XIAMEN ECO LIGHTING CO. LTD., Xiamen (CN)

(72) Inventors: Yongzhe Dong, Xiamen (CN); Xiaoliang Wen, Xiamen (CN); Shoujiang Hou, Xiamen (CN); Caibin Li, Xiamen (CN); Yizhen Chen, Xiamen (CN)

(21) Appl. No.: 16/559,748

(22) Filed: Sep. 4, 2019

(51) Int. Cl. F21L 14/00; F21V 21/002; F21V 23/06; F21V 23/04; F21V 3/02; F21V 17/16

(52) U.S. Cl. CPC F21L 14/00; F21V 21/002; F21V 23/06; F21Y 2113/17; F21V 23/0471; F21V 3/02; F21V 17/164; F21V 23/0428

(57) ABSTRACT

The light device includes a shell housing, a container located in the shell housing, and a light source assembly disposed inside the container. The light source assembly is configured to operate in a first mode to emit light of a first quality and to operate in a second mode to emit light of a second quality. The light device also includes a plug disposed on the shell housing, and the plug is electrically connected to the light source assembly. A window is arranged on the shell housing for allowing light emitted from the light source assembly to pass through. A proximity sensor is configured to enable the light source assembly to switch between the first mode and the second mode.

### BACKGROUND OF THE INVENTION

### Field of the Invention

The present invention is related to a light device, and more particularly related to a night light device with a smiling circular shape.

### SUMMARY OF THE INVENTION

According to an embodiment, the light device includes a shell housing, a container located in the shell housing, and a light source assembly disposed inside the container. The light source assembly is configured to operate in a first mode to emit light of a first quality and to operate in a second mode to emit light of a second quality. The light device also includes a plug disposed on the shell housing, and the plug is electrically connected to the light source assembly. A window is arranged on the shell housing for allowing light emitted from the light source assembly to pass through. A proximity sensor is configured to enable the light source assembly to switch between the first mode and the second mode.

For example, when the light source assembly operates in the first mode, the light source assembly is configured to emit light of a first luminance; when the light source assembly operates in the second mode, the light source assembly is configured t emit light of a second luminance different from the first luminance. In another example, when the light source assembly operates in the first mode, the light source assembly is configured to emit light of a first color temperature; when the light source assembly operates in the second mode, the light source assembly is configured to emit light of a second color temperature different from the first color temperature.

The light device may further include a light passing shell disposed on the window. The light passing shell may include a diffuser.

According to the embodiment, the light source assembly includes a control circuit board, and a light source disposed on the control circuit board. The plug may be rotatable and disposed at a bottom of the bottom housing. The control circuit board has a circular shape.

The container may include a fixing column, and the control circuit board is fixed to the fixing column.

The shell housing may include a bottom housing and a face cover. The container is disposed on the bottom housing, and the face cover is disposed on an opening of the container. The window is disposed on the face cover. The bottom housing and the face cover form a circular shape with a circular cross section.

The face cover may include a convex surface and a concave surface. The convex surface and the concave surface are connected by a curve lateral wall. The convex surface, the concave surface, and the lateral wall form a smiling shape. The window is disposed on the lateral wall, and includes a curve shape.

The face cover may include a USB socket disposed on the face cover. The light source assembly includes a control circuit board. A USB connector and a charging circuitry are disposed on the control circuit board. The charging circuitry is electrically connected to the USB connector, and the USB connector is electrically connected to the USB socket.

The face cover and the bottom housing may be detachably connected with a clip structure. The clip structure includes a first clip located on the bottom housing and a second clip located on the face cover. The first clip is capable of connecting to the second clip for fixing the face cover onto the bottom housing.

The plug may include a plug base and metal pins disposed on the plug base. The plug base is connected to the bottom housing with a rotatable shaft.

The light device may further include a switch configured to switch between a first state and a second state. When the switch is switched to the first state, the light source assembly only operates in the first mode and never switches to the second mode; when the switch is switched to the second state, the proximity sensor detects presence of an object and enables switching between the first mode and the second mode accordingly.

### BRIEF DESCRIPTION OF DRAWINGS

FIG. 1 is a structure diagram according to the first embodiment.

FIG. 2 is the structure diagram according to the first embodiment from another viewpoint.

FIG. 3 is an exploded view of the first embodiment.

FIG. 4 is a structure diagram according to the second embodiment.

FIG. 5 is the structure diagram according to the second embodiment from another viewpoint.

FIG. 6 is an exploded view of the second embodiment.

FIG. 7 is a structure diagram according to the third embodiment.

FIG. 8 is the structure diagram according to the third embodiment from another viewpoint.

FIG. 9 is an exploded view of the third embodiment.

FIG. 10 is a structure diagram according to the fourth embodiment.

FIG. 11 is the structure diagram according to the fourth embodiment from another viewpoint.

FIG. 12 is an exploded view of the fourth embodiment.

### DETAILED DESCRIPTION

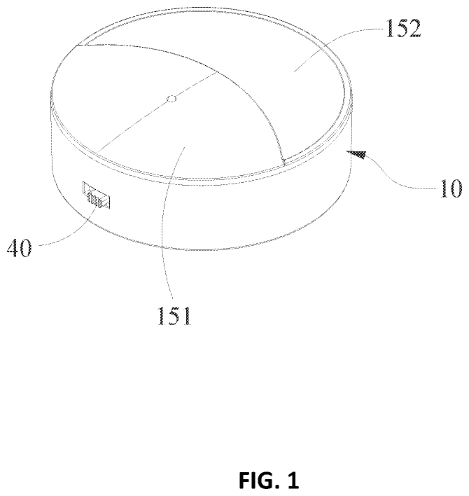

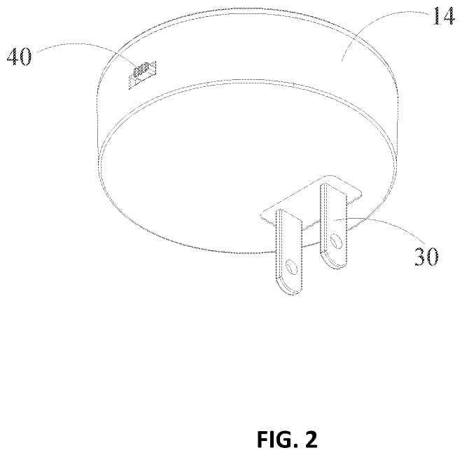

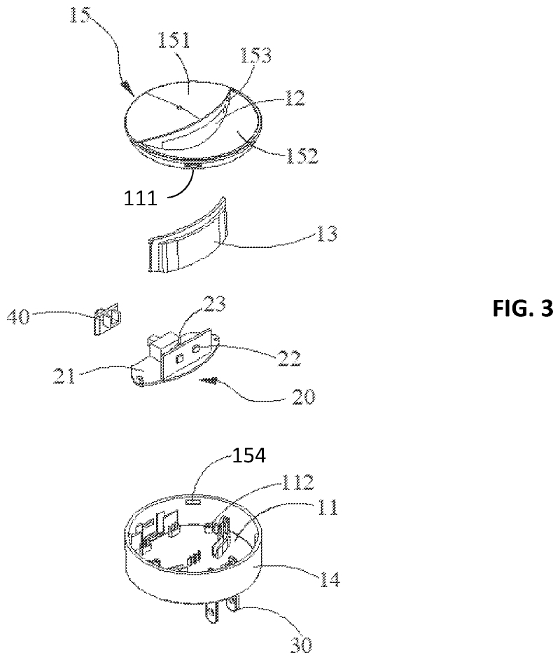

FIGS. 1 to 3 illustrates the first embodiment of the present invention. FIGS. 1 and 2 shows the appearance of the first embodiment from different viewpoints, and FIG. 3 shows the exploded view of the first embodiment.

As shown in FIG. 1-3, the light device is a night light, which has a simple structure and small size, is easy to be assembled and carried by the user to anywhere, and has low production cost. The light device includes a shell housing 10, a container 11 located in the shell housing 10, and a light source assembly 20 disposed inside the container 11. The light source assembly 20 is configured to operate in a first mode to emit light of a first quality and to operate in a second mode to emit light of a second quality. The first quality and the second quality may refer to light of different luminance, or light of different color temperatures.

The light device includes a plug 30 disposed on the shell housing 10, and the plug 30 is electrically connected to the light source assembly 20 for receiving external power and providing power to the light source assembly 20. A window 12 is arranged on the shell housing 10 for allowing light emitted from the light source assembly 20 to pass through to the outside of the shell housing 10 and illuminate the environment.

The light source assembly 20 includes a control circuit board 21, and a light source 22 disposed on the control circuit board 21. The light source 22 includes a plurality of LED chips capable of emitting light.

A proximity sensor 23 is configured to enable the light source assembly 20 to switch between the first mode and the second mode. When no object is detected by the proximity sensor 23, the light source assembly 20 operates in the first mode; when an object is detected by the proximity sensor 23, the light source assembly 20 is switched to the second mode; when the object is no longer detected by the proximity sensor 23, the light source assembly 20 is switched back to the first mode.

For example, the light source assembly 20 may emit light of a first luminance in the first mode, and emit light of a second luminance different from the first luminance in the second mode. As an example, the first luminance is lower than 1 lux, and the second luminance is higher than 1 lux. With such arrangement, when the user is at rest, the light source assembly 20 operates in the first mode, only some of the LED chips in the light source 22 are enabled so the light source assembly 20 emits light lower than 1 lux to help the user fall sleep. When the user gets up and approaches the light device, the proximity sensor 23 detects such movement and triggers the light source assembly 20 to switch to the second mode, all of the LED chips in the light source 22 are enabled so the light source assembly 20 emits light higher than 1 lux so as to properly help the user see clear the environment.

For another example, the light source assembly 20 may emit light of a first color temperature in the first mode, and emit light of a second color temperature different from the first color temperature in the second mode. The light source 22 includes a first group of LED chips capable of emitting light of a first color temperature (e.g., 2,900K), and a second group of LED chips capable of emitting light of a second color temperature (e.g., 3,500K). When no object is detected by the proximity sensor 23, the light source assembly 20 operates in the first mode, the first group of LED chips are enabled and the second group of LED chips are disabled, so the light source assembly 20 emits light of 2,900K; when an object is detected by the proximity sensor 23, the light source assembly 20 would be switched to the second mode, the first group of LED chips are disabled and the second group of LED chips are enabled, so the light source assembly 20 now emits light of 3,500K; when the object is no longer detected by the proximity sensor 23, the light source assembly 20 would be switched back to the first mode and emits light of 2,900K.

It is noted that in this example both the first color temperature and the second color temperature are preferably lower than 4,000K; the first color temperature is preferably equal to or lower than 3,000K, which is preferred for enhancing sleeping environment. With such arrangement, when the user is lying in bed and resting, the light source assembly 20 operates in the first mode and emits light of 2,900K, which could help the user fall sleep. When the user gets up and approaches the light device, the proximity sensor 23 detects such movement and triggers the light source assembly 20 to switch to the second mode, the light source assembly 20 emits light of 3,500K, which is “whiter” than 2,900K so as to properly help the user see clear the environment but at the same time not “too white (e.g., higher than 4,000K)” and makes the user less likely to feel sleepy. When the user returns to bed and rest, the proximity sensor 23 no longer detects any movement, so the light source assembly 20 is switched back to the first mode and emits light of 2,900K.

The light device may further include a switch 40 disposed on the shell housing 10, and the switch 40 is configured to switch between a first state (e.g., ON state) and a second state (e.g., AUTO state). When the switch 40 is switched to the first state (ON state), the light source assembly 20 ignores the proximity sensor 23 and only operates in the first mode and never switches to the second mode; when the switch 40 is switched to the second state (AUTO state), the proximity sensor 23 detects presence of an object and enables switching the light source assembly 20 between the first mode and the second mode accordingly.

The light source assembly 20 further includes an adjustment device (not shown) for adjusting the qualities of the light emitted by the light source assembly 20. The adjustment device may include a selector for optionally enabling one or a plurality of the LED chips in the light source 22, so the light source assembly 20 may emit light of different qualities and switch between the first mode and the second mode.

The light device further includes a light passing shell 13 disposed on the window 12. The light passing shell 13 may include a diffuser to diffuse the light emitted by the light source assembly 20 to enhance the lighting effect of the light device.

The container 11 includes a fixing column 112, and the control circuit board 21 is fixed to the fixing column 112.

The shell housing includes a bottom housing 14 and a face cover 15. The container 11 is disposed on the bottom housing 14, and the face cover 15 is disposed on an opening of the container 11. The window 12 is disposed on the face cover 15. The bottom housing 14 and the face cover 15 form a circular shape with a circular cross section appearing like a round face.

The face cover 15 includes a convex surface 151 and a concave surface 152. The convex surface 151 and the concave surface 152 are connected by a curve lateral wall 153. The convex surface 151, the concave surface 152, and the lateral wall 153 form a smiling shape. The lateral wall 153 appears like lips of the smiling face. The window 12 is disposed on the lateral wall 153, and includes a curve shape providing a nice visual effect. The face cover 15 and the bottom housing 14 are detachably connected with a clip structure. The clip structure includes a first clip 154 located on the bottom housing 14 and a second clip 111 located on the face cover 15. The first clip 154 is capable of connecting to the second clip 111 for fixing the face cover 15 onto the bottom housing 14.

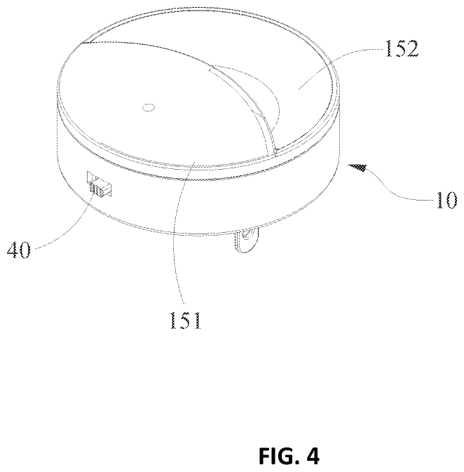

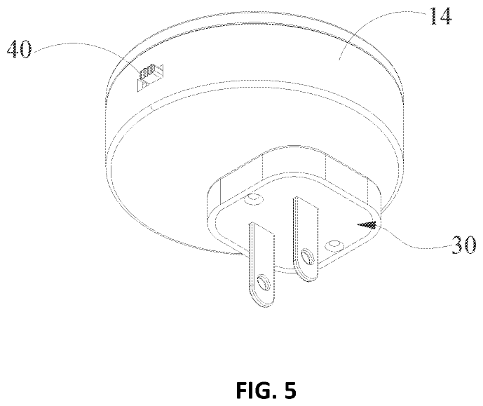

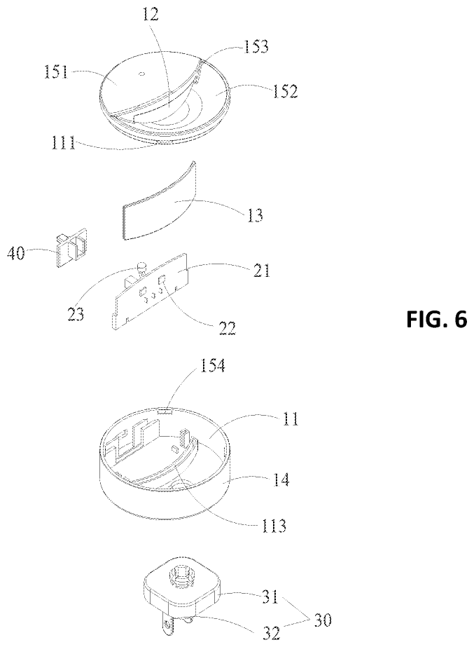

FIGS. 4 to 6 illustrates the second embodiment of the present invention. FIGS. 4 and 5 shows the appearance of the second embodiment from different viewpoints, and FIG. 6 shows the exploded view of the second embodiment. The second embodiment is similar to the first embodiment, except the plug 30 is rotatable and disposed at a bottom of the bottom housing 14. With such configuration, the light device of the second embodiment may be rotated to emit light to a desired direction. The plug 30 includes a plug base 31 and metal pins 32 disposed on the plug base 31. The plug base 31 is connected to the bottom of the bottom housing 14 with a rotation shaft. To provide moving space for the rotation shaft, the control circuit board 21 in this embodiment has a circular shape. There is a socket 113 disposed in the container 11 for plugging the control circuit board 21.

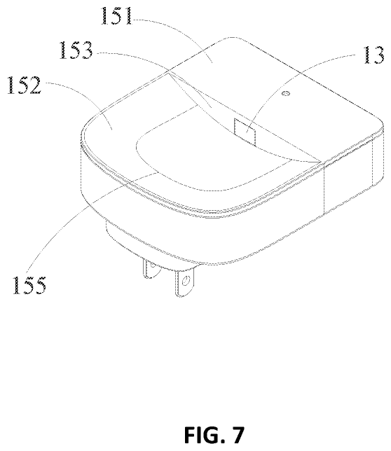

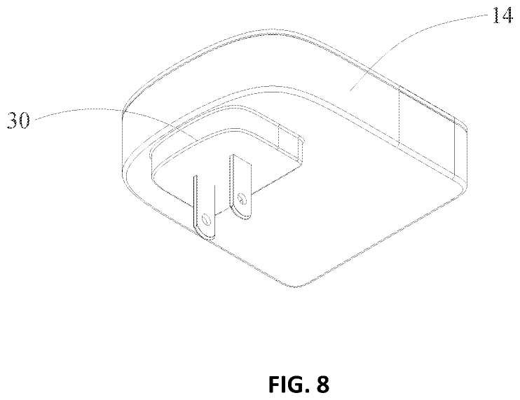

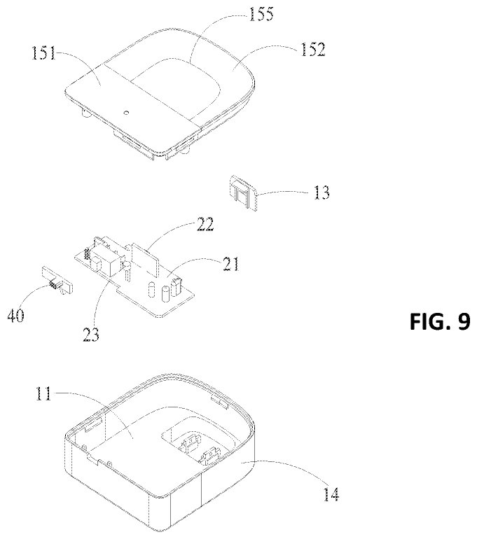

FIG. 7 to FIG. 9 illustrates a third embodiment of the present invention. FIGS. 7 and 8 show the appearance of the third embodiment from different viewpoints, and FIG. 9 shows the exploded view of the third embodiment.

In the third embodiment, the bottom housing 14 is of rectangular shape with a round cross section structure. The lateral wall 153 between the convex surface 151 and the concave surface 152 is not curved; instead, the lateral wall 153 is flat. The window 12 is a bar shape, and the light passing shell 13 is also a bar shape. In addition, there is a border line 155 on the concave surface 152, which appears as a tongue shape while smiling.

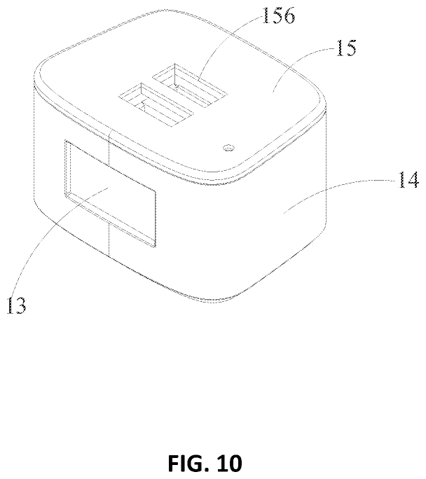

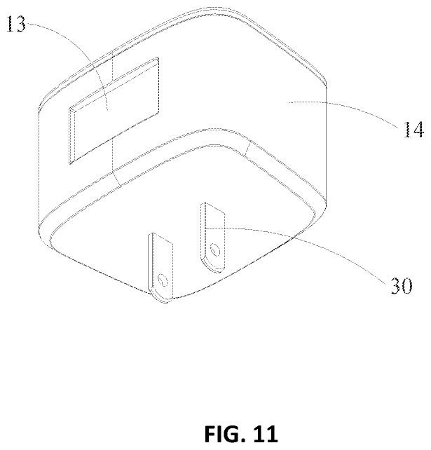

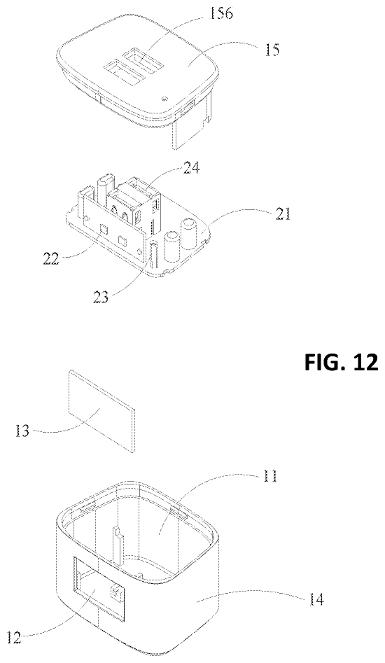

FIG. 10 to FIG. 12 illustrates a fourth embodiment of the present invention. FIGS. 10 and 11 show the appearance of the fourth embodiment from different viewpoints, and FIG. 12 shows the exploded view of the fourth embodiment.

In the fourth embodiment, the light device further includes two USB sockets 156 disposed on the face cover 15 of the shell housing 10 for providing charging capability for the user. Refer to FIG. 12. The light source assembly 20 includes the control circuit board 21 and two USB connectors 24. The USB connectors 24 are electrically connected to the USB sockets 156. The control circuit board 21 further includes a charging circuitry electrically connected to the USB connectors 24 for providing charging capability. In addition, in the fourth embodiment, the cross section of the bottom housing 14 is a square shape with round corners, and the window 12 is disposed on the lateral wall 153 of the bottom housing 14

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A light device, comprising:
a shell housing;
a container located in the shell housing;
a light source assembly disposed inside the container, the light source assembly is configured to operate in a first mode to emit light of a first quality and to operate in a second mode to emit light of a second quality;
a plug disposed on the shell housing and electrically connected to the light source assembly;
a window disposed on the shell housing for allowing light emitted from the light source assembly to pass through, and
a proximity sensor configured to enable the light source assembly to switch between the first mode and the second mode, wherein the light device further comprises a switch configured to switch between a first state and a second state, when the switch is switched to the first state, the light source assembly only operates in the first mode, wherein when the switch is switched to the second state, the proximity sensor detects presence of an object and enable switching between the first mode and the second mode accordingly.

2. The light device of claim 1, wherein the light source assembly further comprises an adjustment device for adjusting the qualities of the light emitted by the light source assembly.

3. The light device of claim 2, wherein the adjustment device includes a selector.

4. The light device of claim 1, wherein the light source assembly is configured to emit light of a first luminance in the first mode, and is configured to emit light of a second luminance different from the first luminance in the second mode.

5. The light device of claim 1, wherein the light source assembly is configured to emit light of a first color temperature in the first mode, and is configured to emit light of a second color temperature different from the first color temperature in the second mode.

6. The light device of claim 1, wherein the light device further comprises a light passing shell disposed on the window.

7. The light device of claim 6, wherein the light passing shell includes a diffuser.

8. The light device of claim 1, wherein the light source assembly comprises a control circuit board, and a light source disposed on the control circuit board.

9. The light device of claim 8, wherein the proximity sensor is disposed on the control circuit board.

10. The light device of claim 8, wherein the container comprises a fixing column, and the control circuit board is fixed to the fixing column.

11. The light device of claim 1, wherein the shell housing includes a bottom housing and a face cover, the container is disposed on the bottom housing, and the face cover is disposed on an opening of the container.

12. The light device of claim 11, wherein the window is disposed on the face cover.

13. The light device of claim 11, wherein the bottom housing and the face cover form a circular shape with a circular cross section.

14. The light device of claim 11, wherein the face cover includes a convex surface and a concave surface.

15. The light device of claim 14, wherein the convex surface and the concave surface are connected by a curve lateral wall.

16. The light device of claim 15, wherein the convex surface, the concave surface, and the lateral wall form a smiling shape.

17. The light device of claim 15, wherein the window is disposed on the lateral wall.

18. The light device of claim 15, wherein the window includes a curve shape.

19. The light device of claim 11, wherein the face cover and the bottom housing are detachably connected with a clip structure.

20. The light device of claim 19, wherein the clip structure includes a first clip located on the bottom housing and a second clip located on the face cover, and the first clip is capable of connecting to the second clip for fixing the face cover onto the bottom housing.

21. (canceled)

22. (canceled)

23. The light device of claim 1, wherein the light device further comprises a USB socket disposed on a surface of the shell housing.

24. The light device of claim 23, wherein the light source assembly comprises a control circuit board, a USB connector and a charging circuitry are disposed on the control circuit board, the charging circuitry is electrically connected to the USB connector, and the USB connector is electrically connected to the USB socket.
